(19) United States
(12) Patent Application Publication
(10) Pub. No.: US 2016/0140846 A1
(43) Pub. Date: May 19, 2016

(54) System and Method for Parking Management Based on Location Tracking

(71) Applicants: Christopher Scott Outwater, Santa Barbara, CA (US); William Gibbens Redmann, Glendale, CA (US)

(72) Inventors: Christopher Scott Outwater, Santa Barbara, CA (US); William Gibbens Redmann, Glendale, CA (US)

(21) Appl. No.: 14/866,368

(22) Filed: Sep. 25, 2015

Related U.S. Application Data
(60) Provisional application No. 62/055,076, filed on Sep. 25, 2014.

(51) Int. Cl. G08G 1/14

(52) U.S. Cl. CPC G08G 1/144

(57) ABSTRACT

In a parking facility, a plurality of beacons are placed near the entrance and pinch points on a path to a venue. If the motorist has pre-loaded the parking application (app) and pre-registered his smartphone, vehicle, and license plate information, along with a valid credit card, then the motorist will be instructed to enter a fast-access parking entrance lane. If the pinch point has a gate, then when the registered customer's phone approaches and sees the beacon, the phone gets the unique ID of the beacon(s) and sends the beacon ID up to the parking management server. The number of beacons along the designated path will increase with proximity to the entrance. Remote processing indicates the exact location of the motorist and then the gate can open. The motorist might need to press “open to enter” button on his phone, but in some fast-access applications this can be optional.

This application is related to, and claims priority from, U.S. Provisional Patent Application No. 62/055,076 filed Sep. 25, 2014. Application No. 62/055,076 is hereby incorporated by reference in its entirety.

### BACKGROUND

1. Field of the Invention

The present invention relates to a system for parking management, more particularly, a system for parking management that relies on a mobile device of the customer to facilitate the transaction.

2. Description of the Problem

There is a growing need for high-speed access, monitoring and billing for both parking and electric vehicle (EV) parking and charging. The present invention deals economically with various issues and can be used in both on-street and off-street parking situations.

Parking lot owners and managers are looking for the least expensive way to allow authorized parking, to manage and control fees in various parking zones, and to allow convenient usage of higher rate parking based on demand, and collect fees for special parking attributes, such as EV charging, if installed in the parking facilities.

It is known in the art that smartphones can communicate using the range of radio frequencies (RF) and protocols defined by BLUETOOTH (BT) and other wireless techniques. A newer version of BLUETOOTH, BLUETOOTH Low Energy (BTLE or BLE) is increasingly popular. Henceforth, the acronym BT will mean both BLUETOOTH and BLUETOOTH Low Energy. Vehicles can broadcast their own identifications (IDs), for example, using something like an RF license plate. Likewise, a vehicle can receive RF signals from a BT transponder. In some embodiments, the vehicle can communicate the number and IDs of occupants, as described in U.S. Provisional Patent Application 61/902,596. entitled “System and Method for Wirelessly Rostering a Vehicle” filed 11 Nov. 2013.

There is a growing use of BT beacons for defining spaces. A beacon can simply be a BT device that identifies itself when in range of another BT device. The advantage of such beacons is that they operate indoors, where global positioning system (GPS) satellites are not accessible. Outdoors, away from tall buildings, GPS can be used. Similar location determinations can be made based on which local area wireless technology (Wi-Fi) base stations are accessible, but beacons have the advantage of having shorter range resulting in better accuracy. Also, BT communications require less power than GPS or Wi-Fi. The beacons themselves are also less expensive. Known applications for such location services include geo-location and geo-fencing. Placement inside shopping malls or stadiums is known in order for an application running on a customer's smartphone to determine the customer's location for contextual marketing or way-finding. Discounts can be offered to customers based on their location.

### SUMMARY OF THE INVENTION

In various embodiments of the present invention, a sequence of inexpensive BLUETOOTH beacons are placed at or near the entrance and pinch points on a path to a venue. If the motorist has pre-loaded the parking application (app) and pre-registered his smartphone, vehicle, and license plate information, along with a valid credit card, if needed for billing, then the motorist will be instructed to enter a fast-access parking entrance lane. This fast-access lane will be clearly defined as requiring registration. Once this registration information is in the database, the motorist only has to register and purchase a date and a venue. If the pinch point has a gate, then when the registered customer's phone approaches and sees the beacon, the phone gets the unique ID of the beacon(s) and sends the beacon ID up to the parking management server. The number of beacons along the designated path will increase with proximity to the entrance, or pinch point. Remote processing indicates the exact location of the motorist and then the gate can open. The motorist might need to press “open to enter” button on his phone, but in some fast-access applications this can be optional.

### DESCRIPTION OF THE FIGURES

Attention is now directed at FIGURES that illustrate features of the present invention.

FIG. 1 shows a parking facility according to an embodiment of the present invention.

Illustrations and drawings have been presented to aid in understanding the present invention. The scope of the present invention is not limited to what is shown in the FIGURES.

### BRIEF DESCRIPTION OF THE PREFERRED EMBODIMENTS

The present invention provides a unified customer experience for both parking and “on foot” experiences associated with a retail space, stadium, or other areas where products are marketed and/or sold.

The present invention allows for economical dynamic pricing as described in U.S. patent application Ser. No. 13/104,309 entitled “System and Method for Managing a Parking Lot”, filed 10 May 2011. Pricing may be based on demand, availability, customer profiles (e.g., loyalty program) and how much a patron is willing to pay at any given time for a parking space. Similar to frequent flier programs and seats on a flight, prices may change based on demand, which in turn is based on time, convenience, loyalty status, and the like.

A system of the present invention generally requires:
A customer's smartphone, or other mobile computer, e.g., one that may reside within a customer vehicle. For the purposes of discussion, the term “smartphone” will be used, but also understood in some embodiments to be a vehicle-based computer.
A parking application (app) running on the smartphone. This parking app may be always running, or can be started as the customer approaches an active location, such as a street, driveway, or other access lane to a parking area. The app may be completely self-contained, or may require communication with the Internet, such communication being, for example, via cellular service or Wi-Fi.
Location-determining services, which outdoors can be GPS, or Wi-Fi, or beacons (e.g., beacons using BLE). In the case of beacons, they would be installed in proximity to key locations, that is, within 100 meters. If Wi-Fi is used, depending on the specific standard selected, the range may be less than 35 to 200 meters. While GPS is usable on most areas of the globe, horizontal accuracy is on the order of 10 meters.
A parking gate, and/or attendant is optional.
A parking management server and database used to track customer information, location information, and transactions, etc.
A portable or stationary enforcement terminal, optionally using license plate recognition (LPR) technology. The enforcement terminal is used to control or monitor access by recognizing those cars for which certain kinds of transactions are expected. For example, the customer information on the parking server may include one or more vehicle license plate numbers. When a license plate number is entered (whether manually or by LPR), the associated account can be identified and checked for prior permission to park, or for billing information for the current fees. The enforcement terminal may have on-demand communication with the parking management server and database, or may rely on periodic updates, e.g., where a relevant portion of the database is downloaded to the terminal for subsequent use.

A smartphone detecting a beacon with the app may simply log contact with a particular beacon for later use. In some cases, the smartphone may detect a beacon with the app (or with a different application) and access the parking management server or another server to register presence near or inquire for information about a detected beacon. In some cases, a beacon or Wi-Fi device may have communication with the parking management server and be able to signal contact by a customer's smartphone. In some cases, the parking management server may have communication to control the parking gate, which may include communication via the customer's smartphone.

As described in U.S. patent application Ser. No. 13/216,173 entitled “System and Method for Providing Internet-based Vehicle Parking Registration and Reservation”, filed 23 Aug. 2011, motorists can pre-register vehicle license plates online and enjoy speedier access to event parking, or schools, or shopping areas.

In the present invention, a customer in a vehicle approaches a parking location (which may be a facility). The customer has a parking app of the present invention running on their smartphone or other mobile computer (e.g., a vehicle-based computer). A location service, which may be beacon-based, (or other location service) signals the app with a first information associated with entering the parking location. Subsequently, as the customer exits the parking location in the vehicle, the location service signals the app with a second information associated with exiting the parking location. The first and second information are provided from the app to the parking management server, signaling a parking transaction.

Depending on policies implemented by the parking management system and new, or predetermined agreements with the customer, the parking transaction may simply be allowed, or may be billed to the customer. The parking transaction may be logged. In some embodiments of the invention, in addition to the first and second information, a third information may be provided to the app by a signal from the location services, while the vehicle is at the parking location. In some embodiments, this third information may be associated within the parking location with a discount location (e.g., a more distant portion of an outdoor parking lot, which may be determined via GPS) or a premium location (e.g., a electric vehicle charging spot, which may be marked with a beacon).

In other embodiments, the third information may be associated with a merchant or service available in or near the parking location, where the merchant or service provider offers to defray the cost of parking, or otherwise authorize parking. For example, in a parking facility for a mall, the movie theater might have a beacon inside to provide the third information, in this case associated with a 4-hour validation for parking. In another example, a beacon or Wi-Fi base station in a doctor's office might authorize parking in a “clients-only” parking facility.

In these embodiments, the third information is provided upon exit, or earlier, in conjunction with an identification of the customer's account. The appropriate discount, premium price, validation, or authorization is associated with the customer's listed vehicles or the ongoing parking transaction tracked by the app.

In some embodiments, the app may be able to determine intervals during which a customer is walking and differentiate these from intervals when the customer is driving. This can be done using accelerometers in the smartphone. This allows a determination of where a customer has parked, based on third information collected around the time of the transition from driving to walking, even if the customer subsequently walks past many other parking spots.

Existing license plate recognition (LPR) entrance methods for fast access are plagued with “exception” issues. Motorists are difficult to predict and control. A motorist can easily get into the wrong lane, such as a fast-access parking entrance lane and then, if detained for even a few seconds or minutes, can defeat the whole purpose of a fast-access lane because all those motorists expecting fast-access are now queued behind him, waiting. In addition, the LPR reading has to be very fast and accurate.

The cost of high speed LPR and installation adds to the risk and the reluctance by parking management companies to implement this technology.

In the present invention, a plurality of strategically placed beacons can help to ward away motorists who are not committed or eligible for fast-access parking. Further, by using “after parking” LPR, the parking facility operators can ignore the “exception” issues upon entry, but still have enforcement and billing capabilities. LPR can still be used at the entrance, but it can be optional and ancillary. The present invention is able to guarantee the accuracy of the parking and billing. For example, if someone unregistered manages to sneak in and park their vehicle in the managed area, or is registered, but not paid to be in that area, we can notify and adjust billing. If there is a small percentage of unenforceable vehicles taking a space without paying, the lot management can deal with that and guarantee any loss in revenue. The speed and accuracy of the present invention can guarantee the owner of the parking and venue that he/she will not have lost revenue.

The enforcement is based on where the motorist claims he/she parked their car based on the location from their phone and where the car is actually parked based on mobile LPR technology that is well-known in the industry. The tagging process for parking is part of our proprietary beacon parking system. Eventually, when cars broadcast their ID's and we will not be relying on the BT from the phone, and determining when driving transitioned to walking, we will not need this car “parked at this location” tagging process.

In a preferred embodiment, a sequence of inexpensive BT beacons are placed at or near the entrance and pinch points on a path to a venue. If the motorist has pre-loaded the app, and pre-registered his smartphone, vehicle, and license plate information, along with a valid credit card, if needed for billing, then the motorist will be instructed to enter the fast-access parking entrance lane. This fast-access lane will be clearly defined as requiring registration. Once this registration information is in the database, the motorist only has to register and purchase a date and a venue. If the pinch point has a gate, then when the registered customer's phone approaches and sees the Beacon, the phone gets the unique ID of the beacon(s) and sends the beacon ID up to the parking management server. The number of beacons along the designated path will increase with proximity to the entrance, or pinch point. Remote processing indicates the exact location of the motorist and then the gate can open. The motorist might need to press “open to enter” button on his phone, but in some fast-access applications this can be optional.

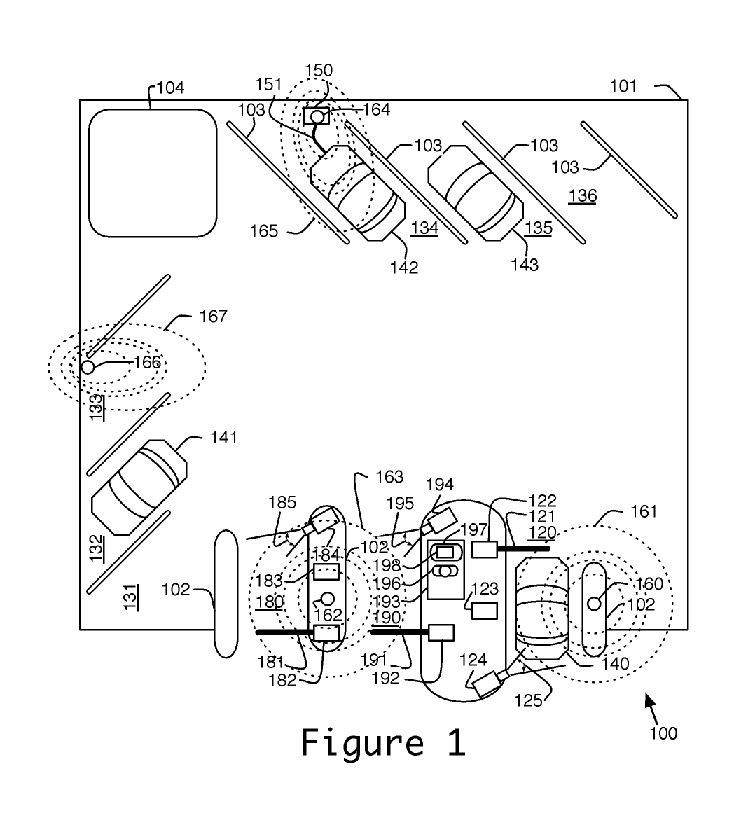

Turning to FIG. 1, a depiction of one floor of a parking facility equipped with beacons can be seen. The features shown in FIG. 1 are as follows:
100 parking facility.
101 secure perimeter (so cars only enter/leave through designated portals).
102 curbs to help channel vehicular traffic.
103 dividers (e.g., lines, curbs) designated individual parking spaces.
104 pedestrian access to stores, elevator lobby, etc. Parking spots in proximity to this (e.g., 133) are higher value than those with otherwise similar amendments that are further away.
120 entry lane—a portal for entering parking lot 100.
121 entry control gate, opens when transaction is successfully initiated to admit car.
122 entry control gate mechanism.
123 entry kiosk, may give driver prices and instructions.
   May spit a ticket for backup, e.g., in case license plate is unreadable.
124 license plate camera (or other device for capturing ‘vehicle characteristic’ upon entry).
   other characteristics can be used instead or in addition:
   3D scan of vehicle for later recognizing it by shape,
   photographic capture of vehicle, to later recognize by its image and the like.
125 field-of-view (FOV) for camera 124.
131 illegal parking space.
132 ordinary parking space.
133 premium parking space (close to pedestrian access 104).
134 EV parking space.
135 ordinary parking space.
136 ordinary parking space.
140 vehicle entering facility at entry portal 120.
141 vehicle.
142 electric vehicle (EV).
143 vehicle.
150 electric vehicle service equipment (EVSE).
151 electric vehicle charging cable.
160 BT beacon
161 beacon field
162 BT beacon
163 beacon field
164 BT beacon
165 beacon field
166 BT beacon
167 beacon field
180 unattended exit lane, also called ‘exit portal’.
181 exit control gate, opens when transaction is successfully concluded.
182 exit control gate mechanism.
183 self-serve automatic exit kiosk.
   displays charges, accepts payment (if an account is not already pre-associated with the vehicle), provides receipt.
184 license plate camera (or other device for capturing ‘vehicle characteristic’ when exiting. for comparison with characteristic captured upon entry, to boost confidence, resolve ambiguities, establish enhanced evidence of transaction)
185 FOV of camera 185.
190 attended exit lane, also called ‘exit portal’.
191 exit control gate (like 181).
192 exit control gate mechanism (like 182).
193 exit booth.
194 license plate camera (or other characteristic capture device, like 184).
195 FOV of camera 194 (like 185).
196 parking lot attendant for assisted transaction.
197 parking management system able to monitor parking transactions by tracking vehicles within parking facility 100.
198 user interface for parking attendant 196, e.g. for accepting cash payments for transactions or assisting a vehicle operator in case of difficulties.

Portions of the present invention can be made more accessible by providing software or hardware modules controlled or accessed with an application programming interface (API) suitable for use with pre-existing or newly created parking management systems. Therefore, if there is a gate, the motorist's phone application needs to communicate with the gate's parking system. Gate access can also be part of a final transaction when the motorist exits the parking area after visiting for a period of time (e.g., determined by the first and second information) and visiting zero or more locations that will be logged in the motorist's smartphone as third information.

The unified parking and “on foot” exploring experience continues after preferred entrance to a parking area.

There are typically a plurality of beacons throughout the parking area and the venue itself. In some embodiments, there can just be beacons in specific parking areas that are recognized by phones that report their location back to the network and database. If there is no cellular service, then the information can be data-muled up to the servers as described in our United States patent applications numbered Ser. No. 13/429,439 filed 6 Mar. 2012 and Ser. No. 14/469/066 filed 26 Aug. 2014.

An attractive aspect of the present invention is that this beacon-based method can be partially implemented by a parking management company at very low cost. The vehicle, more precisely, the driver's or passenger's authenticated phone, is tracked by virtue of the placement of beacons in the parking area. In the future, as vehicles integrate the motorist's smartphone into their dashboards, the system can know the exact location of the smartphone and presumably the owner of the phone and the vehicle.

The present method will request the motorist to press a “park” button on the app when they park their vehicle, so the management system knows where they claim they parked their vehicle. Some unscrupulous motorists might claim to be parked in a less expensive area, set a tag, but actually park their vehicle in a more expensive area. The defense of this tactic system would depend on LPR and parking location enforcement for this purpose.

Within a beacon-monitored-area, vehicles can be guided to the next available parking spot and receive the pricing for that area or space. The spot can have special attributes, such as electric vehicle service (EVSE), or proximity to entrances and exits. One embodiment of the patent allows for the driver to “mark” where he parked his vehicle, so that the system knows the value of that space and location. This is based on the smartphone and beacons, not the vehicle's actual location. The vehicle can also broadcast its own unique ID via the vehicle's RF and the system will be able to know the actual location of the vehicle.

Another aspect of the present invention is to tie a license plate, or a plurality of license plates, registered to the customer's cell phone number and the date and venue, so that enforcement can determine if the customer actually parked one of his registered vehicles where he indicated.

This unified parking management and transaction system allows the highest value to go to both the parking space owner and to the motorist. This system can be automatically tied to other community or loyalty advantage programs at or near the venue. For example, if the customer then goes into a shopping mall and visits other targeted locations, such as retail stores, then a list of visits can be accumulated by the customer's phone. This can lead to the accrual of discounts, thus lowering the parking or entrance fees, perhaps to zero. This may or may not be tied to actual purchases depending on the policy of the property or retail owner.

It is also important to remember that the vehicle's dashboard itself can carry this authentication and owner profile information and will be broadcasting this from the vehicle via a unique, identifying RF signal.

In the mall or stadium or event area, the motorist can gather points perhaps leading to discounts, just by being in proximity of a number of beacons. A chirp or beep, like a video game, can confirm automatically that the customer's account has been credited with a “tag” visit. This may or may not involve a purchase. This system will also help confirm that a customer not only went to a location, but stayed there for a specified period of time. This will limit discount scams in which customers go to a location only for seconds instead of minutes or hours as intended by the sponsor of the discount.

U.S. patent application Ser. No. 14/219,213, entitled “Unified Parking Management System and Method Based on Optical Data Processing”, filed 19 Mar. 2014 teaches that the parking management problem would be solved with optical pattern recognition, such as LPR, plus machine vision to identify and track the movement of vehicles within a parking facility. Color analysis, if needed, to further discriminate between vehicles. The present invention relies heavily on RF beacons or other location services, rather than visual analysis in conjunction with LPR.

As more vehicles become equipped with an RF identification signal, enforcement can utilize the unique RF signal from the vehicle rather than LPR. This can be an active signal, such as an RF tag with battery, or a passive tag that needs to be energized, or an RF signal in the BT range that is active, or needs to be pinged to activate. All of these are possible for enforcement and are within the scope of the present invention. This can be very valuable and more efficient than LPR because an enforcement person or vehicle with an RF reader can rapidly sense and count a large number of vehicles that are in the proper, paid for, parking location. Any overage to the vehicle count can be considered unauthorized parked vehicles requiring enforcement.

LPR can still play an enforcement role, but LPR is not necessary for the present invention to operate. However, tied together, the data gathering methods and system can handle parking access (if gated, or attendant), control, billing and special attributes for parking spaces both economically and with high confidence. In addition, the RF communications process via the beacons carries the experience from the parking area into an entertainment or retail venue for the pedestrian “on foot” customers.

There can, of course, be signage along the entrances, in the walkways and parking areas, that this space is under control of a pre-registered parking system. If a user does not have the app, and is authorized to enter and park in these spaces, then the user will be ticketed and/or towed.

The motorist who had not pre-registered, but who reads the signage, or gets a message on his phone, or over his car radio, will have the option of registering online from their phone or pad. This can happen during approach to pinch point, or after entrance, as long as it is before the enforcement process, which can begin after the parking has ceased for the most part and during the event. Even after enforcement, a customer can be offered to join our service, pay the parking fee, and avoid the additional penalty.

The least expensive way to manage parking areas is with no gates, no pay stations, no attendants and no costly hardware. It is known that LPR alone can be used to handle tracking upon ingress and egress for parking areas. However, once the vehicle is inside the parking area, it is outside the working field of the LPR devices, which take a close “snapshot” of the vehicle's license plate for optical character reading (OCR) processing. Other location-based sources, such as RF beacons alone for smartphones will not be adequate for parking enforcement or validation crediting. The combination of the two types of data gathering, close up LPR and RF beacons, when tied together with techniques known in the LPR and beacon industries, can economically record and monitor access to a parking area and specific zones within a parking area, those zones comprising special attributes, such as proximity to building access, or EVSE for EV charging.

The most economical way to allow EV charging is with no physical access control on the EVSE. Access control and reporting is expensive and complicated. If there is no access control on the EVSE, and if the owner wants to monitor and bill for usage of the EVSE, the owner must rely on both vehicle ID and vehicle location in the parking area through some means so that a specific vehicle can be known to have entered a specific parking area, progressed to a location and parked at a specific parking spot in that location in the parking area for some period of time. As an added attribute, if the vehicle is an EV, then the motorist can plug his EV into an EVSE, if that area is equipped with EVSE as an attribute. The motorist's phone and, when available, his vehicle, can also be tracked until the exit of the parking and charging area and the parking lot in general. This can be tied to monitoring the actual usage of electricity at that parking space using a metering method. The simplest and easiest way is to simply bill for time in a specific parking area or space that has certain attributes. If the parking lot owner wants to bill for kWhs, then they need to meter that EVSE at that space, which involves higher costs to the owner.

This location monitoring system also can become a unified location monitoring system that includes general surveillance features, plus vehicle tracking for access and billing and parking space inventory tracking all in one system. We will be able to provide this information very economically.

Many parking space inventory tracking systems alone require costly hardware to be added in the pavement under the parking space or added to a parking meter. The methods proposed in the present invention do not require any costly hardware to be installed at each parking space. On the contrary, a large number of parking spaces can be monitored by a group of strategically placed beacons, which brings the cost per parking space down significantly.

Predictive analysis technology known in the art can be used to track motion and expected motion through an area as an object transitions from one field of RF of one beacon to another.

This owner and vehicle ID method offers unique features for tracking ingress and egress of known, registered motorists and their vehicles and also unknown, transient, non-registered vehicle that are discovered at enforcement time. Vehicles that are not registered will be able to enter and park in these un-gated and unmanned parking areas; however, if the motorists do not heed the signage instructing them to go online or call in to the parking management offices to register their phones and credit cards and their LP, they might be issued citations, or towed away. Another advantage of the proposed system is that it can also enforce parking by issuing citations based on the LP and also have proof of violation of clearly posted signage and policy. This enforcement can take place automatically as the system can process parking profiles for registered, long term, and also for (non registered, or minimally registered, i.e., LP and credit card) transient parking customers and issue citations when any motorist goes beyond the profile and policies identified by the parking area owner.

The proposed method utilizes a combination of vehicle entrance and exit pinch points and RF beacon recognition techniques along with time and motion and statistical analysis to ID motorists' phones and vehicles on entry, track where the vehicle goes in the parking area, and follow that vehicle until it is parked in a specific parking zone. This concept does not rely on special parking zones and can work in any parking area; however, it allows the parking lot owner to easily create and then bill for parking zones with special attributes.

This has great value not only for billing purposes, but also for general tracking of parking spaces available in large parking structures.

This concept combines two different sensing modalities, RF-based location beacons for the motorist's phone (and later the vehicle itself) and also the vehicle's LP, to tie motorists and their vehicles and where they parked their vehicles using this novel monitoring method that is combined into a unified “in vehicle” and “on foot” solution. It is important to note that this same method and process can be used for rapid entrance for persons “on foot” only as they enter a venue using their smartphone as a token based on the beacons and the application on their phone and having set up an account and paid for the entrance to the venue. This location-based authenticated access can also be sent to another person's phone as a gift or promotion.

During the post-parking LPR enforcement process the “scan and authenticate” time is not of essence in these parking area situations. Unlike event access parking, the cameras can be inexpensive and capture images, cache them, and upload them through wired or wireless means to a secure, remote server for image processing. This is known in the field of image capture and remote sensing. The license plates can then be checked against paid, registered plates for enforcement purposes.

The combination of the two modes of motorist and vehicle ID capture offers the advantage of both, by knowing the ID of the motorist upon approach to a venue pinch point and subsequently the vehicle and its parking location by virtue of the LP data. Also, during this process the system will know where that vehicle is parked, including areas comprised of various (special rate) zones, including an EV charging area.

The motorist is charged based on where actually parked if this is different from where they indicated they would park and the price given them for parking in the intended location.

With a large array of beacons throughout a parking area, the system can determine which areas the vehicle entered and invoice the motorist's account accordingly.

The present invention allows the parking area owner and controller to track the vehicle entrance, movement through the parking areas, and eventual parking location and parking lot status, using inexpensive, beacons and not having to supply expensive LPR cameras, or other parking space vehicle sensors at all of the parking space locations. If there is a parking area with a cluster of EVSE, (note a cluster is likely because this will lower the installation costs per EVSE), then one or two beacons can be located on that parking/charging area, which might cover, for example, ten parking spaces. Motorists who park their vehicles in zones beyond the limits of their profiles, for example, a gas engine vehicle in an EVSE equipped parking spots can be cited for an infraction, or simply billed at the EVSE parking rate, whether they are charging an electric vehicle or not. This allows for a simple flat fee for parking in any specific area and allows the lot owner to install inexpensive EVSE with no access control. There is no reason to have access control because any vehicle parked in that general zone and taking up an EV space, will be tracked to that zone and will be billed for being in that zone.

If this system is used to monitor EVSE in an EVSE zone or area, then the beacon system can also be tied in a database to usage and recording from each EVSE (EV charger). The system would know where the EV is parked, know the exact EVSE space and this can be tied to the power usage at that EVSE.

Further consideration for policy about vehicles entering the monitored parking area is required. The vehicle will either be “known” (pre-registered) or “unknown”. All vehicles are tracked to see which parking zones they enter and in which zone they park. The various zones and their fees will be posted with signage, and offered from the smartphone. The unknown vehicle motorist will be required to call or go online and register with our service and enter their LP into our database. The system will then be able to backtrack and match that LP to the unknown vehicle in the parking area and we will add that vehicle to our paid database. The motorist will have the option of registering as transient (short term) or tenant (long term), as they wish based on the parking area owner and the policy.

In case of enforcement and billing disputes all beacon data and LP images will be available via search capabilities for ID, time and location tracking. This same system can be used to continuously monitor and report spaces available in the various different zones in the parking facility. The owner may decide to set different values for various areas, or attributes of the parking spaces.

Furthermore, if EVSE usage needs to be tracked for billing purposes, this can also be tracked by the system based on the vehicle ID, the location, (the EVSE space number) and the time. Individual EVSE metering can be installed and usage sent via wired or wireless communications to the main server in order to correlate vehicle ID, space number and time with power usage.

In one embodiment, a vehicle is pre-registered online to allow access to a parking area. In another embodiment, the vehicle is unknown and must register after entering the parking area via a computer or smart phone or voice, on phone registration.

The present invention allows the owner to know where the vehicle went in the parking area in two different manners: “dense” tracking and “sparse” tracking. Dense tracking requires a plurality of overlapping beacons covering every 100 feet or so of space in the parking area. This can be used to determine if a vehicle is in a specific zone for tracking purposes and for informing the system about space availability in the parking area. While sparse tracking only requires beacons monitoring an area of interest or higher value, such as a parking zone with special features; perhaps closer to a footpath or entrance, or parking spaces with EVSE. During optional enforcement and LPR the system will know exactly where the vehicle is parked.

The tracking process can also be carried out when the motorist goes “on foot” with his or her smartphone. This is when visits to certain locations as confirmed by the beacons inside the venue, can add to discounts or loyalty points, or other credits of interest to the customer.

Discounts can be offered and codes or barcodes can be sent to the customer's phone so that the discount or coupon can be authenticated at the retail location, or at an entrance to a restricted area within the venue, such as a VIP lounge, etc.

The customer's smartphone and beacons can also be used to help find the customer's vehicle and also help egress from the venue and from the parking area in the most efficient and convenient manner.

Several descriptions and illustrations have been presented to aid in understanding the present invention. One skilled in the art will realize that numerous changes and variations may be made without departing from the spirit of the invention. Each of these changes and variations is within the scope of the present invention.

We claim:

1. A parking lot management system comprising a plurality of radio frequency beacons placed at predetermined locations in a parking facility; a smartphone application adapted to communicate with said beacons allowing the parking management system to track where a particular vehicle parked and for how long.

2. The parking lot management system of claim 1, wherein the radio frequency beacons are BLUETOOTH Low Energy devices.

3. The parking lot management system of claim 1, wherein the radio frequency beacons use WiFi.

4. The parking lot management system of claim 1 further comprising a virtual park key on the smartphone which, when activated, communicates an actual parking location to the parking management system.

5. In a parking facility, a parking lot management system comprising a parking facility control computer, a plurality of RF beacons in the parking facility at predetermined locations, each beacon having a beacon ID; a downloadable application for a smartphone including executable instructions stored in the smartphone and executing on a processor in the smartphone; wherein,
the downloadable application is adapted to communicate with one or more of the beacons as a vehicle enters the parking facility and parks to read beacon IDs, the application being adapted to communicate, a beacon ID, a license plate number, a user account number and a final parking location to the parking facility control computer, the vehicle ID, license plate number and user account number being stored in the smartphone;
the parking lot management system charges an account associated with the account number for parking location and time parked, a final parking location being determined from a particular beacon ID.

6. The system of claim 5 further comprising vehicle registration using the smartphone with a master parking management system that can communicate with the parking facility control computer.

7. The system of claim 5 wherein the beacons are BLUETOOTH Low Energy devices.

8. The system of claim 5 further comprising a virtual park key on the smartphone which, when activated, sends a beacon ID of a closest beacon to parking facility control computer.

9. The system of claim 5 wherein the smartphone app communicates with the parking facility control computer using WiFi.

10. The system of claim 5 wherein the smartphone app communicates with the parking facility control computer using a cellular telephone network.

11. The system of claim 5 wherein the smartphone app communicates with the parking facility control computer over the Internet.
